(19) United States
(12) Patent Application Publication
(10) Pub. No.: US 2008/0116030 A1
(43) Pub. Date: May 22, 2008

(54) GEAR BRAKE DEVICE FOR A MULTI-SPEED MANUAL TRANSMISSION

(75) Inventors: Mario STEINBORN, Friedrichshafen (DE); Ramon Cordt, Friedrichshafen (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 11/874,406

(22) Filed: Oct. 18, 2007

(30) Foreign Application Priority Data
Oct. 24, 2006 (DE) 102006050010.5

(51) Int. Cl. F16H 61/00; F16H 63/50; F16H 61/682

(52) U.S. Cl. 192/223.3

(57) ABSTRACT

The invention relates to a gear brake device for a multi-speed manual transmission (6), comprising a gear brake (14) assigned to an input gear shaft arrangement that can be controlled by a transmission control providing a synchronization function when upshifting the manual transmission (6). In order to expand the functions of the gear brake device, for example in order to shorten the after-run period of auxiliary devices connected to the manual transmission, besides the first gear brake (14), at least one additional auxiliary brake (16, 20) is provided, which acts on the input gear shaft arrangement or on a transmission element (power take-off shaft 18) that is drive-connected or can be drive-connected with it, where said auxiliary brake is operable by the transmission control independently of the first gear brake (14).

This application claims priority from German Application Serial No. 10 2006 050 010.5 filed Oct. 24, 2006.

### FIELD OF THE INVENTION

The invention relates to a gear brake device for a multi-speed manual transmission.

### BACKGROUND OF THE INVENTION

Modern manual transmissions are generally designed in such a way that a plurality of gear wheels fixedly arranged on a drive shaft continuously mesh with freely rotatable gear wheels that are respectively assigned to them and are arranged on a second drive shaft. In order to engage a gear, one of the idlers is rotationally coupled with the assigned drive shaft so that the drive torque of the first drive shaft is transferred to the second drive shaft and from there, ultimately, to a transmission output shaft.

In order to have shock-free, noiseless and low-wear shifting when engaging a gear, it must be ensured that the idler to be coupled and the assigned transmission shaft have at least approximately the same speed. For this kind of speed synchronization, small dimension friction couplings can be used inside the transmission, which, before engaging, frictionally mesh by positive locking coupling devices, thus adjusting the two different speeds to each other.

In another synchronization process, the input side drive shaft, which carries either the fixed wheels or the idlers, is brought to a speed, either through acceleration, by way of the drive engine, or by braking using a gear brake, at which the speeds of the idler to be coupled and assigned gear shaft are essentially equal, so that in this way synchronization is possible without friction clutches.

By definition, in the present invention the gear shafts that can be connected to the drive engine of a motor vehicle, via the input clutch or the drive clutch, are subsumed under the terms “input side gear shaft arrangement”, while the shafts that are permanently connected to the drive gears are designated as “output side shafts” in the present invention.

As is generally known, in order to shift into a lower gear, the input gear shaft arrangement must be brought to a higher rotational speed. This is achieved in that after disengaging the previous gear, the starting clutch is engaged, and the engine speed is increased, via an engine control unit, until the speed required for engaging the positive locking clutch is reached. In order to upshift, the speed of the input gear shaft arrangement must be reduced. This is achieved in that after disengaging the previous gear, the input gear shaft arrangement is braked using a gear brake that acts on one of the gear shafts until the speed required for engaging the clutch is reached.

Conventional manual transmissions comprise an input shaft that is connected to the drive engine via a drive clutch; a countershaft that is connected to it, via a fixed gear wheel connection, which carries a plurality of fixed gears, and a drive-coupled output shaft that is permanently connected with the drive wheels of the vehicle. The idlers assigned to the fixed gears wheels are arranged on the output shaft, the idlers being individually connectable in a rotationally fixed manner with the output shaft in the way described above. In addition, manual transmissions with two countershafts are also known, which allow a particularly short manual transmission design. The present invention is exemplified on the basis of this type of manual transmission where it should be pointed out that the invention is applicable analogously to other transmission designs.

Synchronization by way of the drive engine or by way of a gear brake is applicable in a simple manner particularly to automatic transmissions that already have an engine control unit and transmission control. However, the functional principle can also be applied to manually shifted transmissions.

In general, gear brakes are designed solely for their synchronization function. However, it has been demonstrated that the possibilities of a gear brake are by no means exhausted by the synchronization function. A process is known from DE 10 2004 045 828 A1, by way of which the function of a gear brake can be considerably expanded. According to this process, the use of the gear brake control and regulation goes beyond transmission synchronization without, or as the case may be, with only minimal additional hardware, in order to implement additional drive chain-relevant functions. The additional functions concern the comfort and speed of shifting operations, protection against or identification of error status in sensors, drive clutch, or engine control, as well as avoiding undesirable transmission conditions.

Regarding the possibilities of expanding the functions of a gear brake device, which is also the subject matter of the present invention, express reference is made to DE 10 2004 045 828 A1, the entire disclosure of which is incorporated herein by reference. In order for the gear brake to perform the additional functions effectively and quickly, the design of the gear brake for a braking torque that enables the performance of the additional functions is provided, where this braking torque will, in general, be higher than the braking torque required for the mere synchronization function. For speed synchronization when upshifting the manual transmission, this braking torque is too high as a rule and should, therefore, be controlled though electric impulse modulation. In the case of functional variations in which the additional functions described in the above mentioned document are not required, the gear brake would obviously be over-dimensioned. This would mean that the gear brake would need to produce only part of its potential braking torque for the by far most frequently occurring applications.

Against this background, the task of the present invention is to provide a gear braking device for a multi-speed manual transmission in which, despite the possibility of performing other functions, in addition to the synchronization function, over-dimensioning of the gear brake is avoided.

### SUMMARY OF THE INVENTION

The present invention is based on the knowledge that the total construction and design complexity can be minimized, compared to known transmission brake devices, if the construction and design complexity serving the numerically most frequent synchronization function can be kept to a minimum.

The aim of the present invention is, therefore, a gear brake device for a multi-speed manual transmission that comprises a gear brake assigned to an input gear shaft arrangement; the gear brake being controlled by a transmission control.

In order to achieve this, it is provided that in addition to a first gear brake designed for a synchronization function, at least a further gear brake, which acts on a gear element, which is drive connected and/or can be drive connected to the auxiliary brake that is controllable by the transmission control, independently of the first gear brake.

The auxiliary brake is designed so that it can perform certain auxiliary functions alone or together with the first gear brake. Depending on the provided auxiliary functions, it can have a greater braking torque than the first transmission brake.

In an embodiment of the present invention, apart from the first gear brake, an auxiliary brake is provided inside the transmission housing. In terms of construction and design, it can be completely integrated into the transmission, so that there is no additional assembly effort, nor is a separate auxiliary brake housing required.

According to a further embodiment of the present invention, the first gear brake and the auxiliary brake can act jointly on a gear shaft on a countershaft of the type of manual transmission described above.

The first gear brake and the auxiliary brake can consist of a single two-stage brake arrangement which, when operated, first meshes with the first gear brake and subsequently with the auxiliary brake.

Another embodiment of the present invention provides that the first gear brake and the auxiliary brake act respectively on different gear shafts of the input gear shaft arrangement. Thus, in cases where the transmission has two countershafts, it is provided that the first gear brake acts on one of the countershafts and the auxiliary brake on the other countershaft, such that better load distribution is simultaneously achieved and reinforcement of a countershaft that would have to absorb the braking force of two brakes, is avoided.

A further embodiment of the present invention for a transmission with at least one power take-off shaft external to the transmission, which is drive-connected with the input gear shaft arrangement or can alternatively be drive-connected and provides that at least one auxiliary brake acts on one of the powertake-off shafts. Powertake-off shafts serve to drive auxiliary equipment and are permanently drive-connected with the input gear shaft arrangement or, as in the case of utility vehicles or agricultural vehicles, they serve to drive attached devices, such as hydraulic equipment, which are generally drive-connected with the gear shaft arrangement via clutches. By way of one or a plurality of auxiliary brakes acting on power take-off shafts, the speed of the gear shaft arrangement can also be braked in cases where large rotating masses are driven by way of the power take-off shafts, the masses, after being driven, rotating for a period lasting too long for a shifting operation when unbraked.

A further embodiment of the present invention provides that the first gear brake and further additional auxiliary brake(s) can be actuated consecutively. This means that the gear brake is always actuated first and that at least one auxiliary brake is activated only after the braking force of the gear brake has been determined to be insufficient.

Another embodiment provides that a first gear brake or further auxiliary brake(s) can be actuated simultaneously, the combined braking force being controlled or regulated by the transmission control, both with regard to strength and length of application.

### BRIEF DESCRIPTION OF THE DRAWINGS

The invention will now be described, by way of example, with reference to the accompanying drawings in which:

FIG. 1 schematically shows a drivetrain of a motor vehicle with the transmission having an internal gear brake as well as an optional internal and/or an external auxiliary brake.

### DETAILED DESCRIPTION OF THE INVENTION

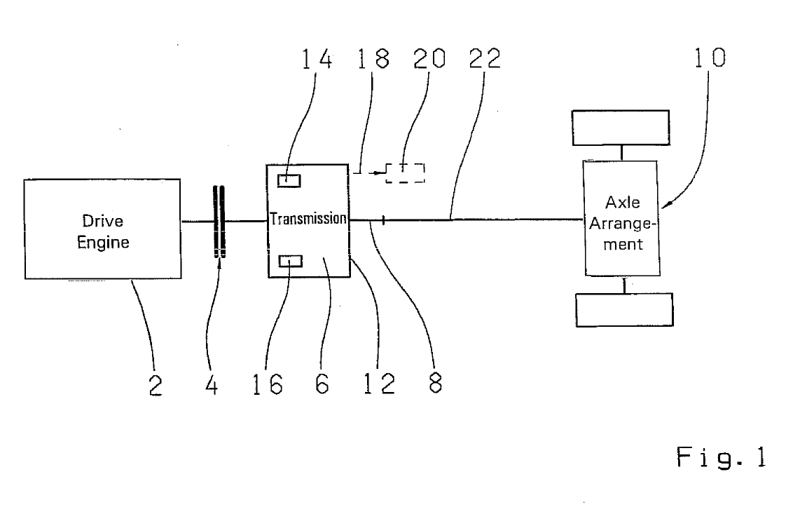

FIG. 1 shows a drivetrain of a motor vehicle with a drive engine 2, a drive clutch 4, a manual transmission 6 downstream of it, and an axle arrangement 10 that is drive-connected with the output shaft 8 of the transmission 6 via a cardan shaft 22. An internal gear brake 14 is arranged inside a transmission housing 12 in known manner, the gear brake interacts with a shaft, for example a countershaft of an input gear shaft arrangement.

According to the present invention, an auxiliary brake 16 is also provided inside the transmission housing 12 and also interacts with a gear shaft of the input gear shaft arrangement when the brake is actuated. As described above, if the transmission has two countershafts, in order to distribute the braking load, the gear brake can interact with one countershaft and the auxiliary brake can interact with the other countershaft.

As FIG. 1 also shows, alternatively to or in addition to the auxiliary brake 16, a power take-off shaft 18 extending out from the transmission housing 12 to an auxiliary device or a second auxiliary brake 20 for driving then auxiliary device or second auxiliary brake 20. The purpose and functions of the auxiliary device or second auxiliary brake 20 have been described above.

### REFERENCE NUMERALS

2 drive engine
4 drive clutch
6 transmission
8 output shaft
10 axle arrangement
12 transmission housing
14 internal gear brake
16 first auxiliary brake
18 power take-off shaft
20 second auxiliary brake
22 cardan shaft

1-8. (canceled)

9. A gear brake device, for a multi-speed manual transmission, comprising a gear brake assigned to an input gear shaft arrangement and being controlled via a transmission control, the gear brake (14) being designed for a synchronization function, at least one additional auxiliary brake (16, 20) is provided, which acts on one of the input gear shaft arrangement and a transmission element (power take-off shaft 18) that is drive connectable, and the auxiliary brake being operable by the transmission control independently of the first gear brake (14).

10. The gear brake device according to claim 9, wherein the auxiliary brake (16), in addition to the first gear brake (14), is provided inside a transmission housing (12).

11. The gear brake device according to claim 10, wherein the gear brake (14) and the auxiliary brake (16) act jointly on one gear shaft.

12. The gear brake device according to claim 11, wherein the gear brake (14) and the auxiliary brake (20) are a single, multi-speed brake arrangement.

13. The gear brake device according to claim 10, wherein the gear brake (14) and the auxiliary brake (16) respectively act on different gear shafts.

14. The gear brake device according to claim 9, wherein at least one auxiliary brake (22), which acts on the power take-off shaft (18), is provided for a manual transmission with at least one power take-off shaft (18) that is drivingly connectable to the input gear shaft arrangement.

15. The gear brake device according to claim 9, wherein the gear brake (14) and the additional auxiliary brakes (16, 20) are actuated consecutively.

16. The gear brake device according to claim 9, wherein a braking force of the gear brake (14) and a braking force of the additional auxiliary brakes (16, 20) are respectively actuated in a controlled manner.

17. A gear brake device for a multi-speed manual transmission, the gear brake device comprising:
a gear brake (14) communicating with an input gear shaft arrangement of the manual transmission (6);
a transmission control for controlling the gear brake (14) to synchronize at least one gear shaft of the manual transmission (6);
at least one auxiliary brake (16, 20) communicating with the transmission control and at least one of the input gear shaft arrangement and a transmission element, that is drivingly connectable with the input gear shaft arrangement; and
the transmission control controlling the at least one auxiliary brake (16, 20) independently of the first gear brake (14).

18. The gear braking device according to claim 17, wherein the gear brake (14) and the at least one auxiliary brake (16) are located inside a housing (12) of the manual transmission (6).

19. The gear braking device according to claim 18, wherein the gear brake (14) and the at least one auxiliary brake (16) interact with the at least one shaft of the manual transmission (6).

20. The gear braking device according to claim 19, wherein the gear brake (14) and the at least one auxiliary brake (20) are a single, multi-speed brake arrangement.

21. The gear braking device according to claim 18, wherein the gear brake (14) interacts with a first gear shaft and the at least one auxiliary brake (16) interacts with a second gear shaft.

22. The gear braking device according to claim 17, wherein the manual transmission (6) has at least one power take-off shaft (18) which is drivingly connectable to the input gear shaft arrangement, and the at least one auxiliary brake (16, 20) interacts with the at least one power take-off shaft (18).

23. The gear braking device according to claim 17, wherein the gear brake (14) and the at least one auxiliary brake (16, 20) are actuated consecutively.

24. The gear braking device according to claim 17, wherein a braking force of the gear brake (14) and a braking force of the at least one auxiliary brake (16, 20) are actuated in a controlled manner.
